(19) United States
(12) Patent Application Publication
(10) Pub. No.: US 2026/0228715 A1
(43) Pub. Date: Aug. 6, 2026

(54) METHOD FOR PAYING FOR GOODS AND/OR SERVICES

(71) Applicant: MERCEDES-BENZ GROUP AG, Stuttgart (DE)

(72) Inventor: Mark GERBAN, Hamburg (DE)

(21) Appl. No.: 18/878,350

(22) PCT Filed: Jul. 3, 2023
(86) PCT No.: PCT/EP2023/068260

§ 371 Date: Dec. 23, 2024

(30) Foreign Application Priority Data
Jul. 7, 2022 (DE) 10 2022 002 474.8

(51) Int. Cl. G06Q 20/32; G06Q 20/40

(52) U.S. Cl. CPC G06Q 20/3229; G06Q 20/325; G06Q 20/40145; G06Q 2220/00

(57) ABSTRACT

An authorized user of a mobile communications unit for goods and/or services by transmitting a user-related parameter set to a mobile phone provider. The mobile phone provider then forwards a request to a payment service provider, which generates a virtual payment card/token and forwards it to the mobile phone provider. The mobile phone provider couples the virtual payment card/token to the SIM/eSIM. The mobile communications unit is integrated in a vehicle and the user-related parameter set is determined by an external server and is transmitted to the mobile phone provider. A user-specific, vehicle-related parameter set is determined by the external server and transmitted to the mobile phone provider. When paying for goods and/or services, the user is authenticated by comparing parameter sets coupled to the SIM/eSIM to the corresponding parameter sets saved with the mobile phone provider and/or on the external server.

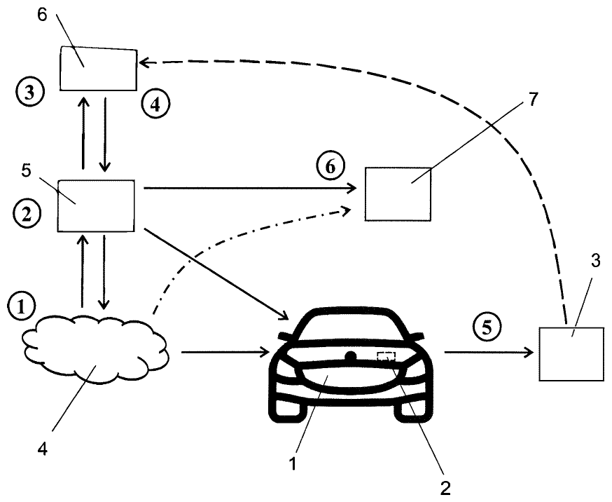

### BACKGROUND AND SUMMARY OF THE INVENTION

Exemplary embodiments of the invention relate to a method for paying for goods and/or services by an authorized user of a mobile communications unit with a SIM or eSIM.

Here, WO 2019/147160 A1 forms the closest prior art. This describes a method for being able to make a payment via a SIM or eSIM in a mobile phone.

Typically, retailers do not accept payment via a SIM or eSIM or do not have the necessary infrastructure in order to offer such payments, which are then typically billed via the mobile phone provider. WO 2019/147160 A1 thus describes a method for generating a virtual credit card or a virtual token from a payment service provider, which can then be coupled to the SIM or eSIM in order to thus make the payment. Here, the only prerequisite for a functioning payment is that the user has correspondingly authenticated themselves on their smartphone, for example by logging into the application used for payment, or if this is permanently activated, has correspondingly authenticated themselves on their smartphone, for example via a PIN, unlocking the smartphone via biometric recognition or similar. The disadvantage is that anyone who has the smartphone can pay with this smartphone as long as they know the PIN or login, for example. The security requirements here are thus comparatively low.

Furthermore, it is known from the prior art that payment can be made from a vehicle. In this context, reference can be made, for example, to EP 3 931 782 A1 or its international counterpart, WO 2021/204411 A1.

Moreover, the prior art also recognizes the possibility of paying from a vehicle via an eSIM, for which reference is made to US 2020/0193411 A1. Here, it is such that the allocation to the respective user is carried out based on their seat inside the vehicle, for example via a camera, before they can then pay using their respective mobile device, such as a smartphone, for example.

On the one hand, based on the prior art discussed above, there is now a desire to be able to make a payment from a vehicle. On the other hand, when using virtual payment cards or virtual tokens that are coupled to a SIM or eSIM, the security concerns described in the context of the prior art discussed at the beginning exist.

Exemplary embodiments of the present invention are therefore directed to an improved option for paying for goods and/or services via a SIM or eSIM from a vehicle.

In the method according to the invention, a SIM or eSIM is used in a mobile communications unit of an authorized user, comparable to the prior art mentioned at the beginning, which is coupled to a virtual payment card or a virtual payment token generated via a payment service provider.

Here, the method according to the invention uses a mobile communications unit that is formed to be integrated into the vehicle. In the context of the invention, such an integration of the mobile communications unit into the vehicle here means that the mobile communications unit is a fixed component of the vehicle and is accordingly fixedly coupled to an operating system and the sensors of a vehicle. Fixed in the sense of the invention is intended to describe the fact that it is not a smartphone or similar coupled in via software or a docking station, but actually a mobile communications unit which is part of the vehicle electronic system and is typically not carried by the user into an area outside the vehicle.

This mobile communications unit integrated into the vehicle is now used in order to correspondingly ascertain a user-related parameter set, which contains at least one user ID of the user. In contrast to the prior art, this parameter set, which can be a vector of different parameters, for example, is thus determined on the vehicle side via a server of the vehicle manufacturer external to the vehicle that is in communicative connection with the vehicle, which is typically referred to as the vehicle backend. The determined parameter set is transmitted from this server to the mobile communications provider. In addition, a vehicle-related parameter set is determined by the vehicle in which the mobile communications unit is integrated, which is user-specific, i.e., takes into consideration both the vehicle and the user correspondingly. This parameter set can, for example, contain a vehicle identification number, which is simultaneously coupled to a user identification on the server external to the vehicle when the user is the owner of the vehicle or is known or stored as a user of the vehicle. This user-specific vehicle-related parameter set is now also transmitted to the mobile phone provider and coupled by it to the SIM or eSIM of the mobile communications unit of the vehicle.

The virtual payment card or the virtual payment token is now used for payment, similar to the prior art mentioned above. At the same time, and this is the decisive advantage in terms of security, the parameter sets coupled to the SIM or eSIM are compared to the corresponding parameter sets stored with the mobile phone provider and/or on the server of the vehicle manufacturer external to the vehicle. This comparison of the parameter sets coupled to the SIM or eSIM on the one hand and the parameter sets stored independently of these by the mobile phone provider and/or on the server of the vehicle manufacturer external to the vehicle on the other hand then serves to authenticate the user in order to thus make the payment and the allocation to the user making the payment very reliable and secure.

According to a very advantageous development of the method according to the invention, it can here be provided that a communication connection is established between the mobile communications unit and the mobile radio provider and/or the server external to the vehicle during payment, in order to transmit the virtual payment card or the virtual payment token coupled to the SIM or eSIM to the mobile communications unit and to compare the parameter sets coupled to it to the corresponding parameter sets stored with the mobile radio provider and/or on the server external to the vehicle of the vehicle manufacturer in order to authenticate the user. The authentication thus here takes place more or less simultaneously with the transmission of the virtual payment card or the virtual payment token, such that the already authenticated data required for payment is transmitted to the provider of the goods and/or services during payment. This makes it possible to make a payment directly, such that the provider of the goods and/or services can process the payment very easily and efficiently without having to take action with regard to authentication.

According to a very advantageous alternative to this, it can also be provided that the virtual payment card or the virtual token and the parameter sets are stored on the SIM or eSIM when it is coupled to the SIM or eSIM. This means that all the information required for payment is available on the SIM or eSIM, such that this scenario also functions when the mobile communications unit does not have a connection to the Internet during the payment process. Here, different virtual payment cards and/or virtual payment tokens can be correspondingly stored, for example in order to be used for different payment transactions. Furthermore, it is also conceivable that only one payment token or virtual payment card is generated and used for several different payment transactions. According to a very advantageous development, the virtual payment card or the virtual payment token and the parameter sets can here be provided with an expiry date, such that they automatically expire a certain time after they are generated, for example for security reasons, and can no longer be used.

As already mentioned above, this process of storage has the advantage that the payment is then also possible without a mobile connection of the mobile communications unit to the Internet. With data stored on the SIM or eSIM during payment, the coupled virtual payment card or virtual payment token and the parameter sets coupled to it can be transmitted to the provider of the goods and/or services. The provider of the goods or services, for example a retailer, a petrol station, a toll station, a ferry or similar, then initiates directly- or indirectly via the payment service provider—the comparison of the parameter sets transmitted to it to the corresponding parameter sets stored with the mobile phone provider and/or on the server of the vehicle manufacturer external to the vehicle. Such a method is also referred to as 3-D Secure, since here several parties and different data paths are used for authentication. In this context, initiated means that the provider of the goods and/or services launches this comparison, preferably via the payment service provider as an intermediary. This has the decisive advantage for the provider of the goods and/or services that it only has to communicate via its conventional communication channels, which it already has with the payment service provider, for example a credit card company or similar. This means that all necessary transactions can be handled by the provider of the goods and/or services via their conventional hardware and/or communication channels, such that they have no further requirements than they already have when using 3-D Secure.

A further very advantageous design of the method according to the invention furthermore provides that data detected by vehicle sensors about the user is included in the user-related parameter set. This further increases the degree of security, since the sensors of a vehicle can detect various values about the user, which are correspondingly known to the server of the vehicle manufacturer external to the vehicle and can thus be included in the user-related parameter set, for example a multidimensional vector, in order to improve the degree of security of authentication.

According to a very advantageous development, the user-related parameter set can here comprise at least biometric data, name, e-mail address, bank details, telephone number, driving behavior, seat settings, data from the area of vehicle access authorization, driving authorization, and/or body data, which are detected, for example, via sensors in the seat or cameras. Here, this data can form the user-related parameter set or be part of this user-related parameter set individually, in combination or as a selected group of said data in combination with one another. The advantage of including data detected via the vehicle sensors is that, on the one hand, the data detection is relatively simple and, on the other hand, this data ensures a high degree of security. If, for example, the vehicle has a biometrically controlled access authorization, which regulates the access authorization for the user by means of a fingerprint, iris recognition, voice analysis, and/or similar, then this data is already detected and known and can be used for the user-related parameter set. Other types of access authorization can also be used, for example by establishing an NFC connection to an access-Attorney authorized smartphone, smartwatch, smart ring, or similar. The mere fact that the person who later uses the mobile communications unit integrated into the vehicle to pay has access authorization for the vehicle is already of relatively high value in terms of authentication security.

Further parameters or data, such as driving behavior or seat settings, for example, can then be used, in particular via the server of the vehicle manufacturer external to the vehicle, to reconfirm that the user who had access authorization and driving authorization for the vehicle is actually the one using the vehicle, because their typical seat settings, typical driving behavior and similar have been recognized.

According to a very favorable design of the method according to the invention, the user-specific vehicle-related parameters can here comprise at least a vehicle identification number and/or the sensor configuration available in the vehicle.

The vehicle identification number is a unique identifier for the vehicle and is abbreviated internationally as VIN (Vehicle Identification Number). Moreover, different vehicles today have different sensors installed, such that the configuration of the available sensors also enables a suitable parameter for identifying the vehicle or at least for differentiating between different vehicles. Moreover, in the event that corresponding sensor data has been used in the user-related parameters to create the parameter set, this sensor configuration must also be available in the corresponding vehicle, since otherwise authentication is not possible in a meaningful way. If the user-related parameter set comprises the body weight of the user, for example, then this also requires a way of recording the body weight. This can be carried out via a corresponding sensor in the seat of the vehicle, for example. If this weight is thus now part of the user-specific parameter set on the one hand and the sensor configuration in the user-specific vehicle-related parameter set on the other hand indicates that a sensor required to record the weight is not available, this can already be a strong indication of potential misuse, which could result in authentication being refused.

A very advantageous design of the method according to the invention now moreover provides that the virtual payment card or the virtual payment token is created and transmitted as a virtual payment card or virtual payment token with cryptogram. For example, such a virtual payment card with cryptogram represents an increase in the degree of security, since payment and thus misuse is not possible with the data of the virtual payment card alone, but that the combination with the corresponding cryptogram is always necessary in order to ensure security. This is fundamentally known from the prior art with conventional methods and further increases the degree of security, especially in this context with payment from the vehicle.

According to an extraordinarily favorable development of the method according to the invention, it is now furthermore the case that the comparison of the parameter sets takes into consideration temporal changes in the individual parameters of the parameter sets using machine learning methods. For example, in a parameter set consisting of a multidimensional vector, one or other parameter can thus change its value over time. This applies, in particular, when data on user behavior is incorporated into the parameter set. For example, the driving behavior, the set seat position, or similar can thus change over time because the user makes corresponding adjustments. Using machine learning methods, these adjustments—or changes that occur over time, for example in the weight of the user or similar—can be recognized and correspondingly taken into consideration. These parameters can be correspondingly tracked using machine learning such that, in the event of a comparison, the system carrying out the comparison can be correspondingly trained to categorize a parameter set for authentication as the same, even if minor changes have occurred in certain parameters where this is possible due to the principle. This efficiently prevents the unnecessary refusal of authentication due to small deviations in individual data of the parameter set, and the system can nevertheless reliably determine whether, for example, the slightly changing driving behavior of a user has occurred as a temporary or creeping change and the use of the vehicle can still be assigned to this user in principle.

According to a very advantageous development of this method, it is here possible that individual parameters are weighted differently when comparing the parameter sets. This makes it possible, for example, to weight unique parameters higher than parameters that may be subject to a continuous or temporary change. This also allows the security of the authentication to be adjusted in the desired way. However, the weighting can also be reversed, such that parameters that reflect the user behavior in the parameter set or vector are given a higher weighting, for example. The background to this consideration may be that it is clearly more difficult to imitate the user behavior than when data such as the name, telephone number and similar of the user is captured by a third party and used illegally for the method described here.

Moreover, it is possible to react appropriately to deviations by using such machine learning methods when using parameters characterizing user behavior. For example, the system can thus be trained to recognize deviations established by machine learning as part of the adjustment and deviations that are currently occurring within the scope of such already established deviations as permissible deviations in order to thus evaluate them as ‘equal’ when comparing the parameter sets in order to thus enable authentication. If there is now a greater deviation than would otherwise typically be established, then there may be a situation in which, for example, someone else is driving the vehicle and exhibits completely different driving behavior or in which, for example, the authorized user is driving the vehicle but is under the influence of drugs or similar. In this case, it can be provided with the method according to the invention that the authentication is refused or at least the maximum amount for payment is restricted in order to protect or self-protect the authorized user, such that, for example, the user under the influence of drugs is not able to spend large amounts of money or an unauthorized user is prevented from paying for expensive goods and/or services at the expense of the authorized user.

As already mentioned above, the virtual payment card or the virtual payment token can be correspondingly stored or, if there is an existing internet connection, also transferred to the mobile communications unit when paying. In practice, it can here be provided that, for example, a virtual payment card or a virtual payment token is used, which is used for several payment transactions. To increase the degree of security, it can then be provided that this is periodically correspondingly renewed in order to ensure verification of the corresponding parameter sets at least from time to time. This can also be handled in a comparable way when coupling and maintaining the virtual payment card or the virtual payment token with the mobile phone provider and/or on the server of the vehicle manufacturer external to the vehicle, i.e., also in the case of an existing internet connection during payment. An alternative to this that is preferred for security reasons, but which correspondingly increases the effort, is to renew the virtual payment card or the virtual payment token for each payment transaction. This means that for each requested payment transaction, a corresponding virtual payment card or a virtual payment token is generated and used according to the method described above. This type of procedure either requires an internet connection of the mobile communications unit during payment or, as already indicated above, can alternatively be solved by storing various virtual payment cards or virtual payment tokens on the SIM or eSIM. For example, three or four cards or tokens can be stored on the SIM or eSIM, such that for these three or four payment transactions, there is the possibility of processing these without an internet connection before this “stock” of possible payment transactions is quasi replenished as soon as an internet connection is available again.

As already mentioned several times, both the mobile phone provider and the server of the vehicle manufacturer external to the vehicle can be used in order to make the comparison. In practice, it is substantially sufficient when this communication relating to the comparison is carried out with the mobile phone provider, which correspondingly receives the virtual payment token or the virtual payment card from the payment service provider and couples it to the SIM or eSIM. In order to be able to make this comparison alternatively or additionally on the server of the vehicle manufacturer external to the vehicle, it can be provided according to a very advantageous design of the method according to the invention that the virtual payment card or the virtual payment token is forwarded by the mobile phone provider- or in parallel to the transmission to the mobile phone provider from the payment service provider—to the server external to the vehicle and stored there. The payment service provider can thus forward the virtual payment card or the virtual token directly to both the mobile phone provider and the server external to the vehicle in parallel. Alternatively, it can also just transmit it to the mobile phone provider, which then in turn forwards it to the server external to the vehicle according to this advantageous design of the method according to the invention. In any case, this creates the possibility of making the comparison either with the mobile phone provider or the server external to the vehicle, and in this case, with the vehicle manufacturer. This opens up additional possibilities when, for example, one of these institutions is temporarily unavailable or similar. Moreover, it enables both the mobile phone provider on the one hand and the vehicle manufacturer on the other to act as service providers and ultimately process the payment for the user. From an economic point of view, this can also be a question of risk assessment, such that either the mobile phone provider or the vehicle manufacturer takes over the payment of the amounts paid via the SIM or eSIM and then demands the amounts incurred from the user.

Further advantageous designs of the method according to the invention moreover emerge from the exemplary embodiment, which is described in more detail below with reference to the figure.

### BRIEF DESCRIPTION OF THE SOLE DRAWING FIGURE

The sole drawing FIGURE shows a schematic depiction of a system for carrying out the method according to the invention.

### DETAILED DESCRIPTION

In the depiction of the single Figure, a vehicle 1 can be seen, in which a mobile communications unit labelled with 2 is installed, which is to be used to pay for goods and/or services with a provider 3 for goods and/or services via its integrated SIM or eSIM.

A server 4 external to the vehicle, depicted here as a cloud, is here connected to the vehicle 1 or its mobile communications unit 2 and provides, for example, a manufacturer's own application in which a user of the vehicle 1 maintains a corresponding account that is coupled to the SIM/eSIM of the mobile communications unit 2 in its vehicle 1. Here, a further communication connection is established between the server 4 external to the vehicle of the vehicle manufacturer and a mobile phone provider 5. For its part, the mobile phone provider 5 is in a communication connection to a payment service provider 6, for example a credit card company or similar. Moreover, the mobile phone provider 5 or, optionally in addition or alternatively, the server 4 external to the vehicle and thus the vehicle manufacturer is connected to a bank 7 of the user of the vehicle 1 as a customer, as well as to the vehicle 1 or its mobile communications unit 2.

Moreover, to explain the process, six individual method steps are symbolically indicated in the sole Figure by the respectively circled numbers 1 to 6. In the first step, which is substantially carried out in the ecosystem of the vehicle manufacturer and thus on the server 4 external to the vehicle, optionally in communication connection to the vehicle 1 or its mobile communications unit 2 and the user of the vehicle 1, first parameters are compiled, which are typically readily available on the server 4 external to the vehicle. These parameters can comprise, for example, the name of the user, their e-mail address, biometric data of the user, their driving behavior, their seat settings, their bank account information, their telephone number and similar. This data then forms a user-related parameter set or at least one part of such a user-related parameter set and can be used in the further course for authentication.

Moreover, a connection of the data of the user to the corresponding data of their vehicle 1 is typically present on the server 4 external to the vehicle, such that vehicle-related parameters such as, for example, the vehicle identification number, a sensor configuration of the vehicle and similar can be linked to the account of the user and thus to the user-related parameter set. This information can be used in order to correspondingly identify the physical unit of the vehicle 1 and the mobile communications unit 2. In particular, when a user owns several different vehicles 1, it is crucial to know the vehicle identification number in order to be able to make a clear assignment and, in the event of such a lack of clear assignments, to be able to optionally block payments. Further parameters that are collected by the sensors of vehicle 1 can also be used, for example transmitted telemetry data, for example in order to record the driving behavior of the user and additionally use this in order to identify them as clearly as possible.

On the one hand, this results in a user-related parameter set and a vehicle-related parameter set on the other hand, which leads to a user-specific vehicle-related parameter set, in particular by linking it with the data of the user. In a second step, these parameter sets are now transmitted to the mobile phone provider 5, which couples the parameter sets with a SIM or eSIM of the user in the mobile communications unit 2 of their vehicle 1. On the one hand, this can take place periodically or only whenever there is a change in one of the parameter sets such that, triggered by this change, the server 4 external to the vehicle sends the corresponding parameter set to the mobile phone provider 5 for renewal.

Based on the data obtained, the mobile service provider 5 can moreover now create a risk profile of the corresponding user, which is typically required since the payments are processed on a credit basis. This means that the mobile service provider 5 initially assumes the costs and bills its customer, for example, on a periodic basis, which makes it necessary for the mobile service provider 5 to be able to assess the risk of whether this bill will also ultimately be paid. As an alternative to the mobile network provider 5, the server 4 external to the vehicle and thus ultimately the vehicle manufacturer, which also knows its customer relatively well, could also take on this risk assessment at this point or, in particular, can directly assume the role of the party that initially settles the payments on a credit basis and then charges them on to its customer. It is therefore possible for the vehicle manufacturer to assume all or part of the role of the mobile phone provider 5 with regard to payment processing, when this is desired.

In the further course, a request of the mobile phone provider 5 to a payment service provider 6, for example a credit card company, is then carried out in the step designated here with three. The request is aimed at creating a virtual payment card or a virtual payment token with or without a cryptogram, preferably with a cryptogram due to the security aspects. This process corresponds to the general prior art.

In the fourth step, the payment service provider 6 sends this virtual payment card or the virtual payment token, in particular and preferably with a cryptogram, to the mobile phone provider 5, which couples it with the SIM or eSIM and the user-related and the user-specific vehicle-related parameter set. Moreover, the virtual payment card or the virtual payment token can preferably be transmitted to the ecosystem of the vehicle manufacturer, in this case to the server 4 external to the vehicle, which also stores the data. A virtual payment card or a virtual payment token can here be generated individually for each payment process or it can be generated or renewed periodically, depending on the security requirements placed on the system.

This approach now enables the user of the vehicle 1 to pay for goods and/or services directly via their vehicle 1 without the need for a credit card or similar. However, since the providers 3 of goods and/or services typically do not support payment via a SIM or eSIM, this is solved by the virtual payment card or the virtual payment token being coupled with the SIM or eSIM and ultimately using it for payment.

The payment itself is then carried out in the fifth step in the depiction of the sole Figure, by for example, when the vehicle 1 or its mobile communications unit 2 has an Internet connection, the virtual payment card or the virtual payment token being transmitted from the mobile phone provider 5 to the mobile communications unit 2 at the start of the payment process. The parameter sets coupled to the SIM or eSIM are then compared to the parameter sets stored on the server 4 external to the vehicle in order to ultimately authenticate the user of the vehicle 1. In the fifth step in this scenario, the provider 3 of the goods and/or services thus receives the authenticated payment information directly, in order to be able to thus process the payment immediately.

An alternative for the fifth step can be the so-called 3-D Secure method. This does not necessarily require an Internet connection. In this case, the virtual payment card or the virtual payment token is stored together with the corresponding parameter sets on the SIM or eSIM of the mobile communications unit 2. This data is transmitted to the provider 3 of the goods and/or services during payment. According to the dashed arrow, the provider then contacts the mobile network provider 5 or the server 4 external to the vehicle in order to initiate the comparison for authentication on its part. Since the provider 3 typically has a connection to the payment service provider 6, i.e., a credit card company for example, it typically and preferably uses this route in order to initiate the comparison. The dashed arrow therefore runs from the provider 3 to the payment service provider 6. This then forwards the corresponding request via the established channels to the mobile phone provider 5 and/or the server 4 external to the vehicle, which then return the authentication if the check is positive, such that the payment process can be reliably completed for the provider 3 of the goods and/or services.

As with a typical credit procedure, either the mobile phone provider 5 or the vehicle manufacturer, symbolized here by the server 4 external to the vehicle, is firstly responsible for payment. These institutions then contact the bank 7 of the user of the vehicle 1, i.e., their customer, in order to have the customer settle the bill accordingly. This is correspondingly shown here as step 6 and is triggered in most scenarios via the mobile phone provider 5, but can optionally also be correspondingly taken on by the server 4 external to the vehicle or the vehicle manufacturer according to the connection depicted dashed.

Since the parameter sets, which can be formed, for example, as an n-dimensional vector, can contain various parameters that could be subject to a continuous change, for example the user's weight, driving behavior of the user or similar, it may make sense to allow certain tolerances, particularly for the parameters that are susceptible to this, when comparing the parameter sets coupled to the SIM or eSIM for payment purposes and the parameter sets stored on the server 4 external to the vehicle and/or at the mobile phone provider 5, before the parameter sets are classified as not being the same and authentication is thus refused. Here, machine learning methods are particularly suitable for enabling reliable functionality here. In doing so, continuous changes, for example in the driving behavior of the user, can be recorded. These changes are typically rather small and can be correspondingly tracked using the machine learning method. Such a method can then also be trained to classify these parameter sets as “the same” when comparing a current parameter set, for example on the server 4 external to the vehicle of the vehicle manufacturer, and a parameter set transmitted for authentication during payment, even when slight deviations have occurred. For example, the knowledge gained from the machine learning method can be used to recognize that although the driving behavior of the user has changed, it basically corresponds to the pattern known from this user, such that it can be assumed from this with a very high degree of probability that the user actually drove the vehicle 1. However, if the deviations are above a threshold that typically occurs during machine learning, it can also be assumed in this context that the change is so strong that either another user is using the vehicle such that authentication should be refused. Alternatively, as already mentioned at the beginning, it would also be conceivable, for example, that the same user is driving vehicle 1 but is under the influence of drugs, for example, i.e., is drunk, for example. In this case, authentication could also be refused.

In both cases, in order not to leave the user completely without a payment option in the event that the user is actually the authorized user, even if this has not been recognized by the system, it can also be provided for such cases that the payments are limited to a maximum amount. This also enables the user to still pay at least smaller amounts even in exceptional situations, for example to be able to fill up with a certain amount of petrol or similar. At the same time, the risk for the authorized user is minimized, since in the event that the payment was not triggered by the user, the damage incurred is limited to this maximum amount.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-14. (canceled)

15. A method for paying for goods and/or services by an authorized user of a mobile communications unit having a SIM or eSIM, the method comprising:
transmitting a user-related parameter set to a mobile phone provider, wherein the mobile phone pro allocated to the SIM or eSIM and is coupled by the user-related parameter set to the SIM or eSIM;
forwarding, by the mobile phone provider after the transmitting of the user-related parameter set to the mobile phone provider, a request to a payment service provider;
generating, by the payment service provider, a virtual payment card or a virtual payment token;
forwarding, by the payment service provider to the mobile phone provider, the generated virtual payment card or the virtual payment token; and
coupling, by the mobile phone provider, the virtual payment card or the virtual payment token to the SIM or eSIM,
wherein the mobile communications unit is integrated in a vehicle,
wherein the user-related parameter set is determined by a server external to the vehicle, wherein the server external to the vehicle is coupled to the vehicle of the vehicle manufacturer,
wherein the user-related parameter set is transmitted to the mobile phone provider,
wherein a user-specific, vehicle-related parameter set is determined by the server external to the vehicle and is transmitted to the mobile phone provider,
wherein the mobile phone provider couples user-specific, vehicle-related parameter set to the SIM or eSIM,
wherein, to authenticate the user when paying for goods or services, the user-related parameter set and the user-specific, vehicle-related parameter set are compared to corresponding parameter sets saved with the mobile phone provider or on the server external to the vehicle.

16. The method of claim 15, wherein when paying, a communication connection is established between the mobile communications unit and the mobile phone provider or between the mobile communications unit the server external to the vehicle, to transfer the virtual payment card coupled to the SIM or eSIM or the virtual payment token and the user-related parameter set and the user-specific, vehicle-related parameter set are compared to the corresponding parameter sets stored with the mobile phone provider or on the server external to the vehicle, in order to authenticate the user, after which authenticated data required for the payment is transmitted to a provider of the goods or services.

17. The method of claim 15, wherein the virtual payment card or the virtual payment token and the user-related parameter set and the user-specific, vehicle-related parameter set are stored when coupling to the SIM or eSIM.

18. The method of claim 17, wherein when paying, the virtual payment card coupled to the SIM or eSIM or the virtual payment token and the user-related parameter set and the user-specific, vehicle-related parameter set are transmitted to a provider of the goods or services, wherein the provider of goods or services directly, or via the payment service provider, initiates the comparison of the user-related parameter set and the user-specific, vehicle-related parameter set with the corresponding parameter sets stored with the mobile phone provider or on the server external to the vehicle.

19. The method of claim 17, the virtual payment card stored on the SIM or eSIM or the virtual payment token and the user-related parameter set and the user-specific, vehicle-related parameter set have with an expiry date.

20. The method of claim 15, wherein the user-related parameter set comprises data recorded by vehicle sensors relating to the user.

21. The method of claim 15, wherein the user-related parameter set comprises at least biometric data, name, email address, bank account details, telephone number, driving behavior, seat settings, vehicle access authorizations, driving authorizations, or body data.

22. The method of claim 15, wherein the user-specific, vehicle-related parameter set comprises at least one vehicle identification number or the sensor system configuration available in the vehicle.

23. The method of claim 15, wherein the virtual payment card or the virtual payment token is generated and forwarded with a cryptogram.

24. The method of claim 14, wherein the comparison of the user-related parameter set and the user-specific, vehicle-related parameter set to the corresponding parameter sets saved with the mobile phone provider or on the server external to the vehicle takes into consideration temporal changes in individual parameters of the user-related parameter set and the user-specific, vehicle-related parameter set using machine learning methods.

25. The method of claim 24, wherein the individual parameters are weighted differently when comparing the user-related parameter set and the user-specific, vehicle-related parameter set to the corresponding parameter sets saved with the mobile phone provider or on the server external to the vehicle.

26. The method of claim 24, wherein when using parameters characterizing the user behavior, in event of deviations, which are greater than deviations established before during the adjustment by machine learning, the authentication is refused or is limited to a maximum amount for the payment.

27. The method of claim 14, wherein the virtual payment card or the virtual payment token is renewed temporally periodically or for each payment process.

28. The method of claim 14, wherein
the virtual payment card or the virtual payment token is forwarded from the mobile phone provider, or
the virtual payment card or the virtual payment token is forwarded to the mobile phone provider from the payment service provider and to the server external to the vehicle and stored by the server external to the vehicle.
